(19) United States
(12) Patent Application Publication
(10) Pub. No.: US 2009/0273254 A1
(43) Pub. Date: Nov. 5, 2009

(54) ENCAPSULATED STATOR OF A DYNAMO-ELECTRICAL MACHINE

(75) Inventor: BRUNO HEIM, Grosseibstadt (DE)

Correspondence Address: HENRY M FEIEREISEN, LLC;HENRY M FEIEREISEN, 708 THIRD AVENUE, SUITE 1501, NEW YORK, NY, 10017, US

(73) Assignee: Siemens Aktiengesellschaft, Munchen (DE)

(21) Appl. No.: 12/434,238

(22) Filed: May 1, 2009

(30) Foreign Application Priority Data
May 2, 2008 (EP) EP08008369

(51) Int. Cl. H02K 3/38

(52) U.S. Cl. 310/195

(57) ABSTRACT

A laminated core of a stator has windings which are arranged in slots and form end windings on the end faces of the laminated core. The end windings are embedded in an encapsulation compound, with the laminated core having a radially outer area formed with at least one axial recess of a contour which is closed in the circumferential direction and through which encapsulation compound can be introduced.

### CROSS-REFERENCES TO RELATED APPLICATIONS

This application claims the priority of European Patent Application, Serial No. EP08008369, filed May 2, 2008, pursuant to 35 U.S.C. 119(a)-(d), the content of which is incorporated herein by reference in its entirety as if fully set forth herein.

### BACKGROUND OF THE INVENTION

The present invention relates to a laminated core of a stator of a dynamo-electrical machine, to a production method for a stator such as this, and to a dynamo-electrical machine having a stator such as this.

The following discussion of related art is provided to assist the reader in understanding the advantages of the invention, and is not to be construed as an admission that this related art is prior art to this invention.

Laminated cores of stators, in particular stators without cooling jackets of dynamo-electrical machines, have until now been encapsulated by means of an encapsulation compound, for example resin, preferably by means of vacuum encapsulation, via bracket slots which are located on the external diameter of the laminated core. This has the disadvantage that the cutouts which are located on the external diameter and are filled with resin can be seen on the external diameter in the case of a stator without a cooling jacket, and the resin can break out. This happens particularly during subsequent machining, with the resin-filled cutouts leading to interrupted cuts, and accordingly causing comparatively high surface roughness.

Furthermore, the highly abrasive nature of the encapsulation compound which is filled, for example, with quartz powder, results in heavy wear of the machining tools, for example turning tools. The abrasive wear in this case represents microscopic chipping.

From the process point of view, the encapsulation must be machined only when wet because the dusts of the fillers in the encapsulation compound, such as those created on chipping, are hazardous to the lungs. When machined dry, the dust that is created must be sucked away. In the end, this leads to increased machining effort.

It would therefore be desirable and advantageous to provide an improved laminated core of a stator of a dynamo-electrical machine to obviate prior art shortcomings and to allow simple and safe subsequent machining while at the same time ensuring fault-free, homogeneous encapsulation, in particular without inclusions.

### SUMMARY OF THE INVENTION

According to one aspect of the present invention, a laminated core of a stator of a dynamo-electrical machine includes a laminated body having opposite end faces, with the laminated body having slots and defining a radially outer area formed with at least one axial recess of a contour which is closed in a circumferential direction, windings received in the slots and forming end windings on the end faces, and an encapsulation compound introduced through the recess for embedding the end windings.

According to another aspect of the present invention, a method of making a laminated core of a stator includes the steps of stamping a slotted laminate to produce at least one recess having a closed contour in a circumferential direction, stacking a plurality of such laminates to form a laminated core having plural slots and defining opposite end faces, inserting windings in the slots of the laminated core, placing the laminated core with the windings in an apparatus, and flooding the apparatus with an encapsulation compound via the recess until end windings of the windings at the end faces of the laminated core are flooded with the encapsulation compound.

The present invention resolves prior art problems by providing at least one recess, preferably more than one recess, which is closed on the outside towards the external diameter of the laminated stator core, so that the radially outer area of the stator core, i.e. an area of the laminated stator core of the dynamo-electrical machine facing away from the air gap, can be provided with axial channels distributed on the outer edge of the stator core for use as a filling channel.

The cross-sectional profile of a channel may be varied within wide limits. However, in order to influence the magnetic flux as little as possible during operation of the dynamo-electrical machine, the contour of the recess is chosen to be flat or in the form of a shell, so as to advantageously conform to the external contour of the laminated core.

A laminated core according to the present invention has a closed external contour which can be machined with comparatively better manufacturing accuracy than the machining quality in the case of an external filling channel and thus in the case of a cut which is in consequence interrupted. This avoids unnecessary abrasiveness of the tools for machining the laminated core. Furthermore, no dusts that are hazardous to health occur during machining, which dusts would have to be avoided by complex machining measures, for example wet machining.

The laminated blank, which has now been optimized for encapsulation, is therefore also suitable for the machining of encapsulated stators. Since the outer channels, which have been filled with encapsulation compound, for example resin, are now no longer machined, but only the casing surface of the stator, this results in the machining tools having longer lives, and thus creates a comparatively smooth surface on the laminated stator core.

The surface roughness is thus reduced and the encapsulated stator can therefore be inserted, in particular pushed, comparatively easily into an installation area that is provided, for example of a machine tool, or a housing or a cooling jacket.

A laminated core according to the invention is beneficial for the end user of the dynamo-electrical machine since no resin remains on the surface of the stator and thus cannot break off later. There is therefore no longer any possibility of resin breaking off in the respective manufacturing process, and causing malfunctions there.

According to another advantageous feature of the present invention, caps or steel rings can be fitted in the end-winding area as a lost encapsulation mould, and a centering edge can be fitted on both sides to the laminated core. These caps or steel rings are shrunk onto this centering edge in order to produce a particularly advantageous seal, in particular during the encapsulation process. The outer web of the cap or steel ring is hereby used as a sealing edge to prevent encapsulation compound from running out.

### BRIEF DESCRIPTION OF THE DRAWING

Other features and advantages of the present invention will be more readily apparent upon reading the following description of currently preferred exemplified embodiments of the invention with reference to the accompanying drawing, in which:

FIG. 1 is a perspective illustration of a laminated core according to the present invention;

FIG. 2 is a plan view of a laminate of the laminated core;

FIG. 3 is an enlarged detailed view of the laminate in an area of a recess;

FIG. 4 is a sectional view of the laminated core, depicting schematically a flow of encapsulation compound in the laminated core;

FIG. 5 is an enlarged detailed view of the area encircled in FIG. 2 and marked V;

FIG. 6 is a schematic illustration of an electrical machine with caps;

FIG. 7 is a side view of a cap; and

FIGS. 8-10 show variations of the cap.

### DETAILED DESCRIPTION OF PREFERRED EMBODIMENTS

Throughout all the figures, same or corresponding elements may generally be indicated by same reference numerals. These depicted embodiments are to be understood as illustrative of the invention and not as limiting in any way. It should also be understood that the figures are not necessarily to scale and that the embodiments are sometimes illustrated by graphic symbols, phantom lines, diagrammatic representations and fragmentary views. In certain instances, details which are not necessary for an understanding of the present invention or which render other details difficult to perceive may have been omitted.

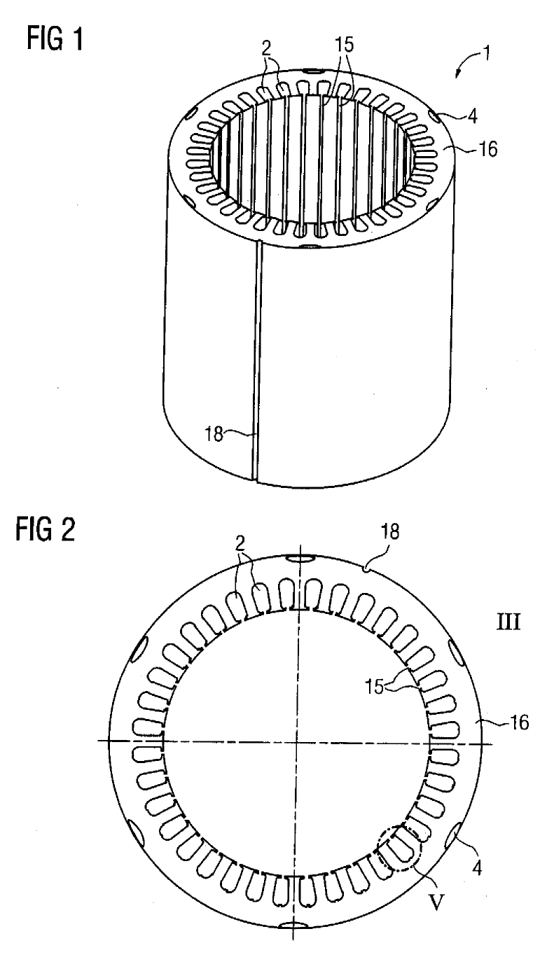

Turning now to the drawing, and in particular to FIG. 1, there is shown a perspective illustration of a laminated core 16 according to the present invention of a stator 1 which has a laminated body formed from individual laminates, shown in FIG. 2, which are arranged axially one behind the other. The stator 1 has axially running slots 2 into which windings 3 are inserted later, not shown in any more detail in this illustration, wherein the windings 3 may be in the form of tooth-wound coil windings or fractional-pitch windings. These windings 3 are in this case dripped via the slot slit 15 into the slots 2, or are drawn in by suitable apparatuses, for example a flyer. The windings 3 in this case form end windings 5 on the end faces 10 of the laminated core 16.

According to the invention, axially running recesses 4, which each have a closed contour, are provided on the radially outer area of the laminated core 16.

In this case, together with corresponding means which are not illustrated in more detail comprising housing, installation and cooling jacket, the longitudinal slot 18 forms a torque support.

In order to allow the idea according to the invention to additionally be used advantageously in stators 1 with inclined slots, the individual laminates are stamped such that, although a slot inclination of about one or two slot pitches is created over the axial length of the stator 1, the recesses 4 are, however, preferably still arranged axially, that is to say without any offset in the circumferential direction. This simplifies the casting process, that is to say the flow resistance in the axially running recesses 4 is correspondingly reduced, which is advantageous particularly when the viscosity of the encapsulation compound is relatively high.

A slot pitch is in this case the distance between two adjacent slots 2 in the circumferential direction.

However, the process of encapsulation of the stator 1 may, of course, also be carried out with inclined slots and with the recesses 4 being inclined at the same time. In the end, there need be only one channel in an essentially axial direction, which carries the encapsulation compound to the other side of the laminated core 16.

FIG. 2 shows a cross section of an individual laminate of the laminated core 16, with the recesses 4 and the slots 2. By way of example, the FIG. in this case shows the number of recesses 4 to be six, in which case this number can be defined, and can therefore be also increased or decreased, before the stamping process of the laminated core 16, depending on the machine size and the volume and/or viscosity of the encapsulation compound to be introduced.

The volume of encapsulation compound to be introduced via the recesses 4 depends inter alia on the overhang of the end winding 5 and/or the number of slots 2 to be filled. Furthermore, the temperature-dependent viscosity of the encapsulation compound, for example the resin, influences the cross-sectional area of the recesses 4 and the effectiveness of the capillary forces.

In this case, the viscosity is a measure of the viscousness of a fluid, in this case of the resin. The higher the viscosity, the thicker is the fluid, that is to say the less freely the fluid flows.

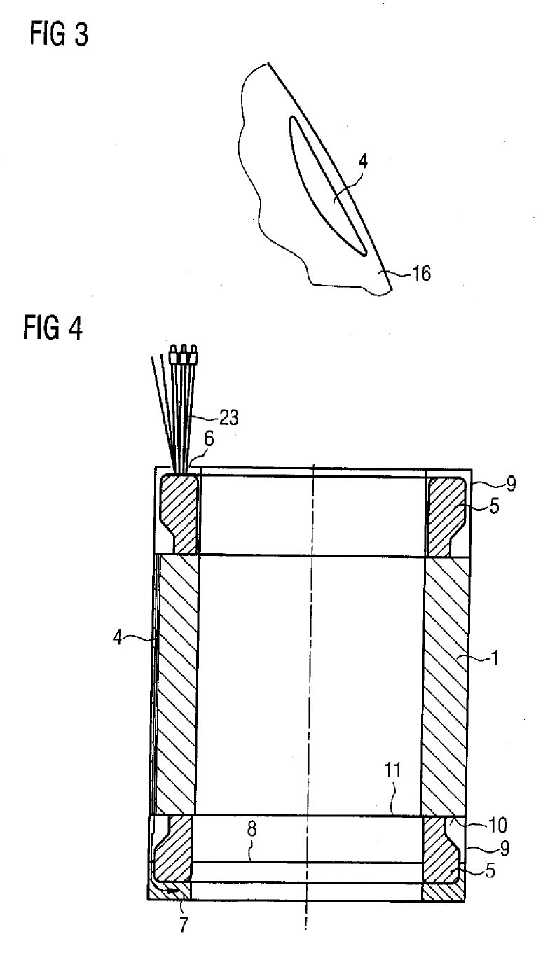

FIG. 3 shows a detailed illustration of an example of a contour of a recess 4 which has a radially smaller extent in comparison to its extent in the circumferential direction. This has the advantage that the profile of the magnetic flux produced by the windings 3 in the laminate 16 during operation of the dynamo-electrical machine is not interfered with, that is to say adversely affected, by a disproportionally large radial extent of the recess 4.

A “ratio of the extent in the circumferential direction to the extent in the radial direction” of greater than or equal to two is in this case advantageous irrespective of the geometric configuration of the contour (ellipse, pea-shaped contour, sickle-shaped contour, etc.).

FIG. 4 shows a stator 1 which is provided with windings 3, with the windings 3 forming end windings 5 on the end face 10 of the laminated core 16, which end windings 5 must be encapsulated for operation of the dynamo-electrical machine, in order to provide insulation within the winding 3 and/or heat dissipation inter alia from the end winding 5.

For this reason, the laminated core 16, which is provided with windings 3, has been preheated to about 90° Celsius and, for example, comprises a core composed of stove-enameled laminates, is inserted into an auxiliary mould 9 which is suitable for the machine type and is filled with resin at atmospheric pressure or at an increased pressure, via at least one inlet 6 and via the recesses 4. The resin, which has likewise been heated to about 90°, flows by virtue of the force of gravity and/or pressure and optionally making use of the known principle of vacuum encapsulation, through the axial recess 4 and, at the lower end of the auxiliary mould 9, enters the area of the end winding 5 located at the bottom. As further liquid resin is added, the resin level 8 rises until it first of all reaches the lower edge 11 of the laminated core 16. On this side of the laminated core 16, the end winding 5 has therefore then been completely filled with or surrounded by resin.

From the lower edge 11, the resin is drawn further “upwards” essentially by capillary forces. This capillary effect occurs inter alia between the winding wires located in the slots 2, in particular copper wires. The slots 2 are therefore also encapsulated with resin. The further addition of resin results in encapsulation of the end winding 5 located on the other side of the laminated core 16.

In order additionally to encapsulate only the laminated core 16 of the stator 1, the area of the stator bore in the laminated core 16 is occupied by a cylindrical stamp, which is essentially not shown in any more detail. This ensures homogeneous encapsulation, with few inclusions, particularly in the area of the slots 2.

The connections 23 of the windings 3 project out of the auxiliary mould 9, out of an inlet 6 or a further specific opening. The connections 23 in this case represent the power connections for example to a converter and/or lines of sensors from the stator 1, for example temperature sensors.

The entire resin-encapsulated assembly, that is to say the laminated core 16, recesses 4, intermediate spaces located in the slots 2, end windings 5, is then cured in an oven at about 80 to 100° Celsius.

FIG. 5 shows a detailed illustration of a slot 2 with grooves 17 which, for clarity reasons, has been illustrated without a winding 3 and without slot insulation 21. In this exemplary embodiment, by way of example, the slot 2 has three grooves 17 which run in the axial direction of the laminated core 16 and are used, in addition to the capillary forces, for distribution of the resin in the slot 2. The number of grooves 17 per slot 2 may be less than or more than three.

A wavy profile of one or more grooves 17 on the slot walls 30, 32 is likewise feasible. By way of example, a groove 17 would thus run from the left-hand slot wall 30, over the slot base 31 to the right-hand slot wall 32, when considered over its axial profile. However, only wavy profiles of a groove 17 within a slot wall 30, 32 or the slot base 31 are likewise feasible. If there are a plurality of grooves 17 in each slot 2 and they have different wave profiles, it is possible for the grooves 17 to intersect on the slot walls 30, 32 and/or on the slot base 31.

The grooves 17 are produced by the stamping process of the laminate, ensuring during the stacking of the laminated core 16 that not only the recesses 4 but also, if present, the grooves 17 allow resin to flow through in the opposite direction to the resin flow direction in the recesses 4, during the production of the stator 1.

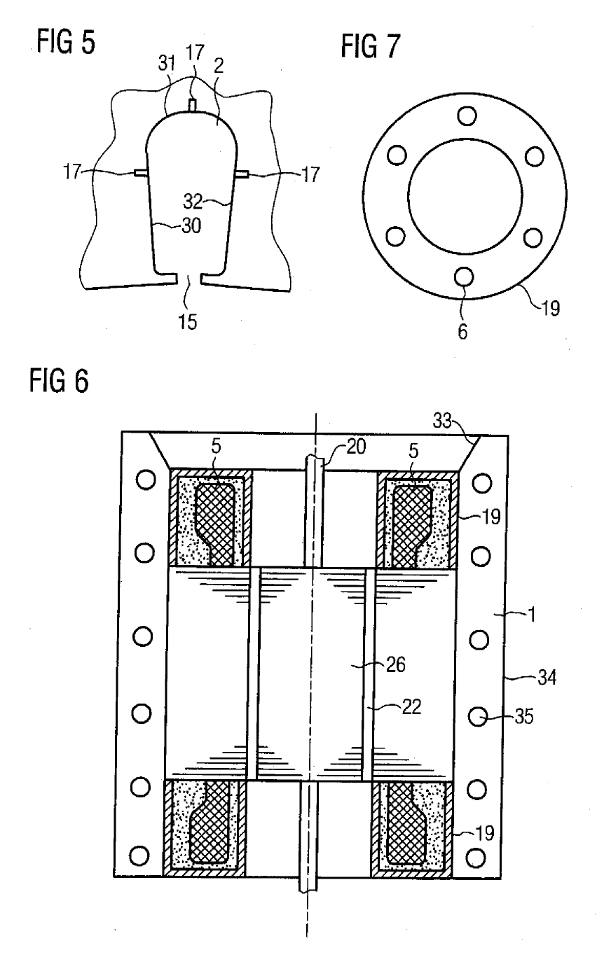

FIG. 6 shows a dynamo-electrical machine, illustrated in outline form, which drives a shaft 20 and has a rotor 26 and a stator 1. By way of example, the rotor 26 is a reluctance rotor, that is to say a rotor with permanent magnets or a rotor with electrical excitation. The winding 3 of the stator 1 is in this case illustrated only in outline form, in the same way, as well, as the disproportionally long distance between the winding 3 or the end winding 5 and the air gap 22 of the dynamo-electrical machine.

The end windings 5 are surrounded by resin which, in addition to providing electrical insulation, also allows heat to be transported outward, in this case in particular to the annular cap 19. This cap 19 dissipates the heat from the heat sources in the dynamo-electrical machine, for example the end winding 5, laminated core 16, air gap 22, to a heat sink, which is arranged radially outside the stator 1 and is in the form of a housing and/or cooling jacket 34.

Alternatively, these caps 19 can also be fitted retrospectively to the end windings 5, which have been provided with resin, and can advantageously be provided with thermally conductive paste, in order to improve the thermal conductivity.

However, at the same time, these caps 19 advantageously represent a casting mould, which is positioned before the casting process on the end faces of the laminated core 16 and is then cast, inter alia via the recesses 4. The caps 19 are therefore a lost casting mould which, in addition to simplifying the production of the stator 1, also provide characteristics that assist cooling during operation of the dynamo-electrical machine. This is the case in particular with caps 19 composed of highly thermally conductive material, for example, copper, aluminum, etc.

As shown in FIG. 7, the caps 19 have inlets 6 on at least one side of the laminated core 16, via which the encapsulation compound, for example the resin, is introduced. The connections 23 of the windings 3 are passed out of a specific opening or an inlet 6, before the encapsulation process.

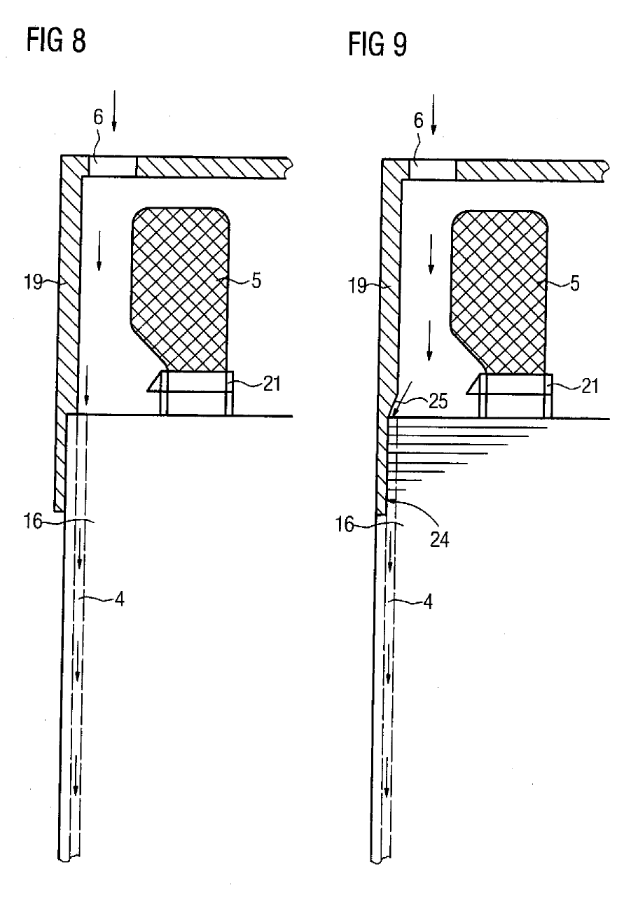

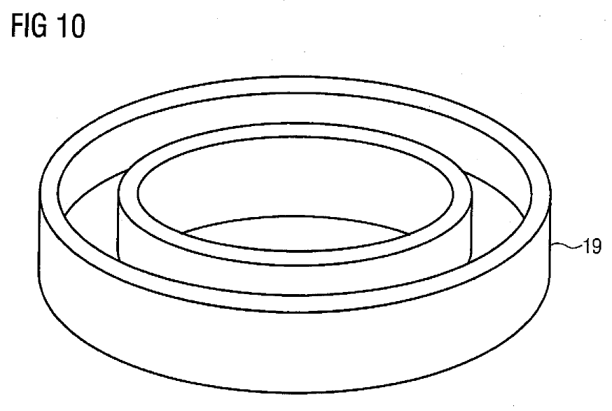

FIG. 8 and FIG. 9 show, in principle, how a reusable auxiliary mould 9 or the cap 19 which remains on the stator 1 is positioned on the laminated core 16. This is done either by the auxiliary mould 9 or the cap 19 being pressed onto the external diameter of the laminated core 16 or by pressing it onto a collar 24 which is turned on the laminated core 16. In the last-mentioned case, a chamfer 25 or a milled area of the cap 19 is provided in the area of the recess 4 in order to ensure that the resin is opposed by as little flow resistance as possible on its way into the recess 4.

The inlets 6 of both an auxiliary mould 9 and of a cap 19 are ideally located in an axial extension of the recesses 4 in order to provide the encapsulation compound with access with as little impediment as possible to the respectively corresponding recess 4.

As shown in FIG. 10, the cap 19 forms an annular groove in which the end winding 5 is located after completion of the dynamo-electrical machine. In this case, as shown in FIG. 6, the ends of this groove in each case rest on the laminated core 16 in order in this way on the one hand to ensure sealing during the encapsulation process, and to provide heat transport out of the laminated core 16 during operation of the dynamo-electrical machine, as well.

It is advantageous for the cap 19 to rest on the laminated core only in places, or not at all, on the side facing the air gap. Contact is therefore made there with the laminated core 16 only in places, or there is a circumferential gap. This avoids eddy currents which could otherwise result owing to the closed circuit—laminated core 16, cap 19, laminated core 16—on an end face of the laminated core 16. Since the pressure of the encapsulation compound is comparatively low in this area, the sealing is also subject to relatively minor requirements.

However, if the gap has to be sealed, a narrow ring composed of insulation material can also advantageously be added to the cap 19 in this area, thus once again resulting in a completely closed groove.

After the encapsulation process, the resin therefore surrounds the end windings 5, fills the recesses 4 and is located in the slots 2 between the winding wires and, if present, between the slot insulation 21 and the slot walls 30, 32 and the slot base 31.

The slot insulation 21 in this case projects at least over one end-face end of the laminated core 16 on which the inlets 6 are located.

The invention is suitable for encapsulated mounting spindles without cooling jackets since the heat dissipation from the end windings 5 is at the same time also increased by the end-winding encapsulation.

The invention is likewise suitable for dynamo-electrical machines which have a cooling jacket 34 and/or a housing, and surround the stator 1 on the outer casing surface, as shown in FIG. 6.

In order to insert the stator 1 and, in this case, the dynamo-electrical machine particularly advantageously into an installation area provided for this purpose in a production machine, into a housing and/or into a cooling jacket 34, it is particularly advantageous for the stator 1 to be in the form of a hollow cylinder, in particular with a smooth outer and/or inner casing.

The cooling jacket 34 has, for example, at least one cooling channel 35 which runs in a spiral shape around the stator 1.

The installation of the stator 1 in its installation area is made easier by the installation area of the housing, or the cooling jacket 34, providing a widened cross section 33 as shown in FIG. 6.

While the invention has been illustrated and described in connection with currently preferred embodiments shown and described in detail, it is not intended to be limited to the details shown since various modifications and structural changes may be made without departing in any way from the spirit and scope of the present invention. The embodiments were chosen and described in order to explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and includes equivalents of the elements recited therein:

What is claimed is:

1. A laminated core of a stator of a dynamo-electrical machine, said laminated core comprising:
a laminated body having opposite end faces, said laminated body having slots and defining a radially outer area formed with at least one axial recess of a contour which is closed in a circumferential direction;
windings received in the slots and forming end windings on the end faces; and
an encapsulation compound introduced through the recess for embedding the end windings.

2. The laminated core of claim 1, wherein the encapsulation compound is resin.

3. The laminated core of claim 1, wherein each slot has at least one groove.

4. The laminated core of claim 1, wherein the recess has a flat configuration.

5. The laminated core of claim 1, wherein the recess is filled with the encapsulation compound.

6. The laminated core of claim 1, wherein the contour of the recess is configured in the form of a shell.

7. The laminated core of claim 1, wherein the recess has a radial dimension which is less than a dimension in circumferential direction.

8. The laminated core of claim 1, wherein the dimension in circumferential direction is twice the radial dimension.

9. The laminated core of claim 1, further comprising a cap attached to the stator core to surround the end windings.

10. The laminated core of claim 9, wherein the cap has an inlet fluidly connected to the recess for introduction of the encapsulation compound.

11. The laminated core of claim 9, wherein the cap is press-fitted upon the laminated body at least in an area of the recess and formed with a chamfer in the area of the recess to minimize flow resistance as the encapsulation compound enters the recess.

12. The laminated core of claim 9, wherein the cap has ends resting against the laminated body to provide a seal and thereby prevent escape of encapsulation compound as the encapsulation compound enters the recess.

13. A dynamo-electrical machine, comprising a stator including a laminated core having opposite end faces, said laminated core having slots and defining a radially outer area formed with at least one axial recess of a contour which is closed in a circumferential direction, windings received in the slots and forming end windings on the end faces, and an encapsulation compound introduced through the recess for embedding the end windings.

14. The dynamo-electrical machine of claim 13, constructed in the form of a mounting spindle.

15. The dynamo-electrical machine of claim 13 constructed in the absence of a cooling jacket.

16. The dynamo-electrical machine of claim 13, further comprising a cap to surround the end windings.

17. A dynamo-electrical machine, comprising:
an enclosure; and
a stator accommodated in the enclosure and including a laminated core having opposite end faces, said laminated core having slots and defining a radially outer area formed with at least one axial recess of a contour which is closed in a circumferential direction, windings received in the slots and forming end windings on the end faces, and an encapsulation compound introduced through the recess for embedding the end windings.

18. The dynamo-electrical machine of claim 17, wherein the enclosure is a member selected from the group consisting of housing and cooling jacket.

19. The dynamo-electrical machine of claim 17, further comprising a cap to surround the end windings.

20. A method of making a laminated core of a stator, comprising the steps of:
stamping a slotted laminate to produce at least one recess of a closed contour in a circumferential direction;
stacking a plurality of said laminate to form a laminated core having plural slots and defining opposite end faces;
inserting windings in the slots of the laminated core;
placing the laminated core with the windings in an apparatus; and
flooding the apparatus with an encapsulation compound via the recess until end windings of the windings at the end faces of the laminated core are flooded with the encapsulation compound.

21. The method of claim 20, wherein the recess is stamped at a radially outer edge of the laminate.

22. The method of claim 20, wherein the encapsulation compound is resin.

23. The method of claim 20, wherein the apparatus is an auxiliary mould or a cap, and further comprising the step of covering the end windings by the auxiliary mould or cap before the flooding step to direct the encapsulation compound to flow into the auxiliary mould or cap.
